(19) United States
(12) Patent Application Publication
(10) Pub. No.: US 2004/0135655 A1
(43) Pub. Date: Jul. 15, 2004

(54) Tuneable dielectric resonator

(76) Inventors: Peter Petrov, Wembley (GB); Alford Neil McNeil, London (GB)

Correspondence Address: Anthony R Barkume, 20 Gateway Lane, Manorville, NY, 11949, US

(21) Appl. No.: 10/474,762

(22) PCT Filed: Apr. 10, 2002
(86) PCT No.: PCT/GB02/01712

(51) Int. Cl. H01P 7/10

(52) U.S. Cl. 333/235

(57) ABSTRACT

A method of tuning a dielectric resonator uses a ferroelectric element to change the dielectric resonator electric field and hence the resonance frequency of the dielectric resonator.

This invention relates to dielectric resonators.

Dielectric resonators (DRs) are key elements for filters, low phase noise oscillators and frequency standards in current microwave communication technology. DRs possess resonator quality factors (Q) comparable to cavity resonators, strong linearity at high power levels, weak temperature coefficients, high mechanical stability and small size.

Ceramic dielectric materials are used to form thermally stable DRs as key components in a number of microwave subsystems which are used in a range of consumer and commercial market products. These products range from Satellite TV receiver modules (frequency converter for Low Noise Broadcast (LNB), Cellular Telephones, PcN's. (Personal Communication Networks Systems) and VSAT (Very Small Aperture Satellite) systems for commercial application to emerging uses in transportation and automobile projects, such as sensors in traffic management schemes and vehicle anti-collision devices. Dielectric Resonators may be used to determine and stabilise the frequency of a microwave oscillator or as a resonant element in a microwave filter. New systems of satellite TV transmission based on digital encoding and compression of the video signals determine, the need for improved DR components. The availability of advanced materials will also enable necessary advances in the performance of DRs used for these and other purposes.

In DRs in the areas of communications over a wide frequency range, low dielectric loss materials are highly desirable, for example in the base stations required for mobile communications. Dielectric resonators using dielectric sintered ceramics are commonly used and the dielectric materials used are often complex mixtures of elements. One of the earliest resonator materials was Barium Titanate (BaTiO₃ or BaTi₄O₉ see for example T. Negas et al American Ceramic Society Bulletin vol 72 pp 90-89 1993).

The dielectric loss of a material is referred to as the tan delta and the inverse of this quantity is called the Q (Quality Factor). The Q factor of a resonator is determined by choosing a resonance and then dividing the resonant frequency by the bandwidth 3 dB below the peak.

In microwave communication technology dielectric resonators are well known and widely used circuit elements for filters, low phase noise oscillators and frequency standards. By altering the electric field of the dielectric resonators (which in turn affects the magnetic field) is it possible to change tune their resonant frequency. Usually a dielectric resonator is tuned by a tuning screw, made from either metal or dielectric material, from above, below or through the dielectric element (when ring shape dielectric resonators is used). The speed of tuning is limited by the time of tuning screw movement.

In view of these considerations, a need exists for fast tuning of dielectric resonators without reducing of the Q factor.

For fast resonance frequency changing an electrical tuning element is included in the control (input/output) circuit. As electrical tuning elements pin-diodes or ferroelectric based devices are used. Having a Q factor few orders of magnitude less than the one of dielectric resonators, electrical tuning elements reduce the quality factor of the whole circuit. Therefore their use in communication equipment is limited.

Attempts to improve the tuning ability of dielectric resonators are disclosed in U.S. Pat. Nos. 4,728,913, 5,049,842, 4,630,012, 4,385,279, and 4,521,746, but the currently used methods suffer from disadvantages.

We have devised an improved method of tuning dielectric resonators which overcomes these difficulties.

According to the invention there is provided a method of tuning a dielectric resonator which method comprises changing the frequency of the resonator by a frequency changing means which is operated using a ferroelectric element.

In the method of the invention the ferroelectric element changes the electric field of the resonator which changes the frequency of the resonator.

The invention also provides a tuneable dielectric resonator comprising a cavity within which is mounted a dielectric and a frequency changing means, which frequency changing means is operated using a ferroelectric element.

Preferably the ferroelectric element is a ferroelectric film which is formed on a substrate or on the resonator cavity bottom, the resonator upper plate, or on one or more of the resonator surrounding cavity walls. Alternatively the ferroelectric element can surround the dielectric resonator.

In one embodiment the ferroelectric element comprises a conductive substrate on which there is a ferroelectric film to which film is connected an upper conductive electrode. On applying a dc bias, the relative permittivity of the ferroelectric film decreases and hence affects the dielectric resonator electric field and changes the resonance frequency of the dielectric resonator.

The conductive substrate is preferably formed of a metal such as silver, or a high melting point metal such as Pt, Pd, high temperature alloy, etc.

Any ferroelectric material can be used and preferred materials are BaₓSr₁₋ₓTiO₃ (BSTO) films. Th films can be deposited on the substrate by conventional methods such as forming a film paste of ferroelectric material on the substrate and heating the paste, magnetron sputtering, PLD, sol-gel, MOCVD, e-beam/thermal evaporation, etc.

The upper conductive electrode can be made of a high conductivity metal such as, but not restricted to, silver or gold and electrically connected to the ferroelectric element.

In a device of the invention preferably the ferroelectric element is spaced apart from the dielectric resonator by a spacer formed of a low loss dielectric material, for example, but not limited to, quartz, Al₂O₃, polystyrene etc., Because of the gap between the ferroelectric element and the dielectric resonator due to the spacer, the coupling between the dielectric resonator and the ferroelectric film is weak and reduction of the Q-factor is not significant.

In a preferred embodiment of the invention the ferroelectric element is formed as a film on the conductive base which is supported on the floor of the resonator. The dielectric element and spacer are ring shaped and the spacer is positioned on the ferroelectric element and the dielectric element is placed on the spacer, the wire electrode then passes through the spacer and the dielectric element and is connected to the ferroelectric element. A dc bias can then be passed through the ferroelectric element between the conductive substrate and the electrode to decrease the relative permittivity of the ferroelectric film and hence change the dielectric resonator electric field.

The invention provides a sensitive rapid means of tuning a dielectric resonator.

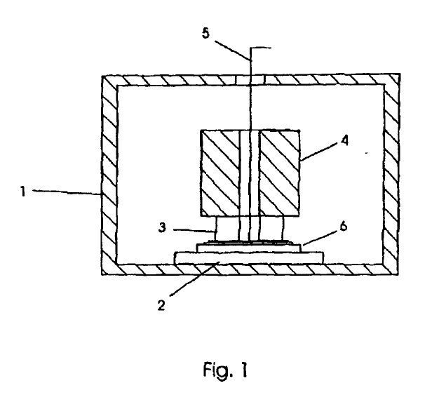

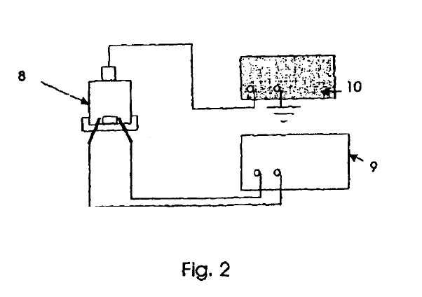

A resonator is illustrated in FIG. 1 of the drawings and a tuning circuit shown in FIG. 2.

Referring to FIG. 1 a resonator cavity (1) has a conductive substrate base (2) on the surface of which is formed a ferroelectric film (6) which is the ferroelectric element. There is a ring shaped spacer (3) on which is supported the ring shaped dielectric (4). Wire (5) passes through the ring shaped dielectric (4) and spacer (3) and is soldered to ferroelectric fin (6) through a silver electrode.

In use a circuit was set up as in FIG. 2 with the resonator (S) part of a circuit with network analyser (9). The power was applied across the ferroelectric film (6) through the wire (5) and the conductive substrate (2). By applying a the voltage from power supply (10), the dc bias across the ferroelectric film (6) is increased which decreases the relative permittivity of the ferroelectric film and hence changes the dielectric resonator electric field. In conjunction with the network analyser (9) the resonator can then be tuned by varying the dc bias.

The invention is described in the Examples in which Ag disks (20 mm in diameter, 1 mm thick) were used as conductive substrates for growing of BaₓSr₁₋ₓTiO₃ (BSTO) films. In the examples below, the BSTO thick film possessed a significant degree of porosity (50-60%) and this reduced the effective ε_{P} and hence the tuning capability is reduced. It is thought that reducing porosity would improve performance.

### EXAMPLE 1

A thick film paste of BSTO was prepared with BSTO powder (Ba/Sr ratio 75%/25%). The powder was thoroughly mixed with a vehicle comprising non-aqueous polymers and solvents. The thick film paste was applied on to the surface of the silver disc. The paste was dried at 80° C. and then the composite was fired at 900° C. for 6 hours. The thickness of the BSTO fin was between 80-120 μm.

An upper Ag electrode was prepared by applying a silver paste.

A 0.2 mm in diameter wire was soldered onto the centre of the upper electrode.

A ring shaped quartz spacer is placed on the upper electrode and the ring shape dielectric resonator (unloaded Q=3,400 at 7.3 GHz) is placed upon the quartz spacer. The wire which has been attached to the upper electrode passed through the central hole of both quartz spacer and dielectric resonator.

The measurement setup was assembled as presented on FIG. 2. Using a high voltage power supply a dc bias was applied on the BSTO film resulting in electric field of 3.5 kV/cm. The TE₀₁₁ node was shifted by 2 MHz.

The results are shown in Table 1.

TABLE 1

| | Centre Frequency | Centre Frequency | |
|---|---|---|---|
| | (GHz) | (GHz) | Quality Factor |
| Bias Voltage (V) | (Ascending) | (Descending) | (Q) |
| 0 | 7.6541 | 7.6537 | 1138 |
| 50 | 7.6542 | 7.6538 | 1142 |
| 100 | 7.6546 | 7.6541 | 1143 |
| 150 | 7.6551 | 7.6546 | 1111 |
| 200 | 7.6555 | 7.6552 | 1043 |
| 250 | 7.6558 | 7.6556 | 1028 |
| 300 | 7.6559 | 7.6558 | 1011 |
| 350 | 7.6561 | 7.6561 | 1005 |

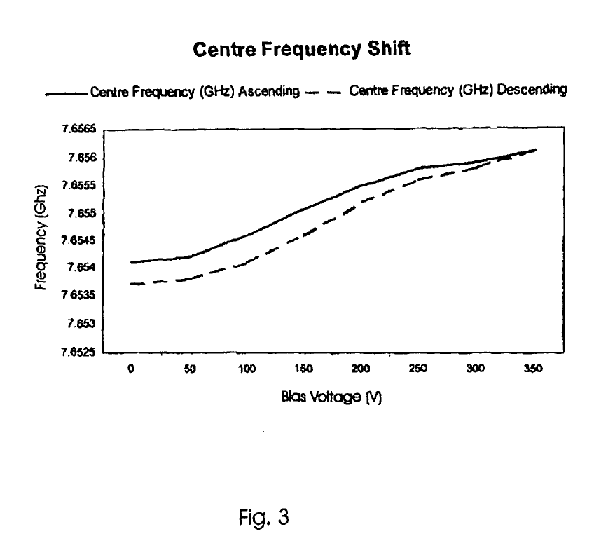

Graphs showing the results are shown in FIG. 3

### EXAMPLE 2

The procedure in example 1 was repeated except that the ferroelectric film of different composition (B_{B}_{_{0.50}}Sr_{0.50}TiO₃) was used which resulted in shifting of the TE₀₁₁ mode by 1.2 MHz. The results are shown in Table 2

TABLE 2

| | Centre Frequency | Centre Frequency | |
|---|---|---|---|
| | (GHz) | (GHz) | Quality Factor |
| Bias Voltage (V) | (Ascending) | (Descending) | (Q) |
| | 7.3745 | 7.3745 | 1770 |
| 50 | 7.3744 | 7.3745 | 1800 |
| 100 | 7.3745 | 7.3745 | 1780 |
| 150 | 7.3746 | 7.3746 | 1660 |
| 200 | 7.3748 | 7.3747 | 1420 |
| 250 | 7.3746 | 7.3748 | 1170 |
| 300 | 7.3737 | 7.3741 | 1150 |
| 350 | 7.3733 | 7.3733 | 1350 |

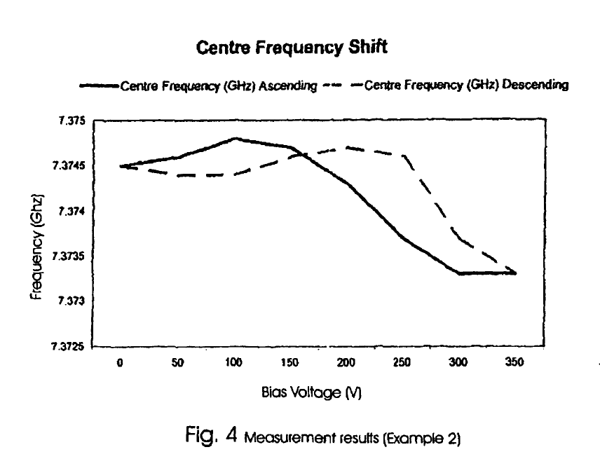

Graphs showing the results are shown in FIG. 4

### EXAMPLE 3

The procedure in example 1 was repeated except that the DR of Al₂O₃ (Q=1,800) at 9.4 GHz) was used which rest in shifting of the TE₀₁₁ mode by 1 MHz.

The results are shown in Table 3.

TABLE 3

| | Centre Frequency | Centre Frequency | |
|---|---|---|---|
| | (GHz) | (GHz) | Quality Factor |
| Bias Voltage (V) | (Ascending) | (Descending) | (Q) |
| 0 | 9.6025 | 9.6025 | 938 |
| 50 | 9.6024 | 9.6026 | 938 |
| 100 | 9.6026 | 9.6027 | 942 |
| 150 | 9.6028 | 9.6028 | 912 |
| 200 | 9.6030 | 9.6030 | 889 |
| 250 | 9.6032 | 9.6031 | 842 |
| 300 | 9.6033 | 9.6032 | 800 |
| 350 | 9.6035 | 9.6035 | 755 |

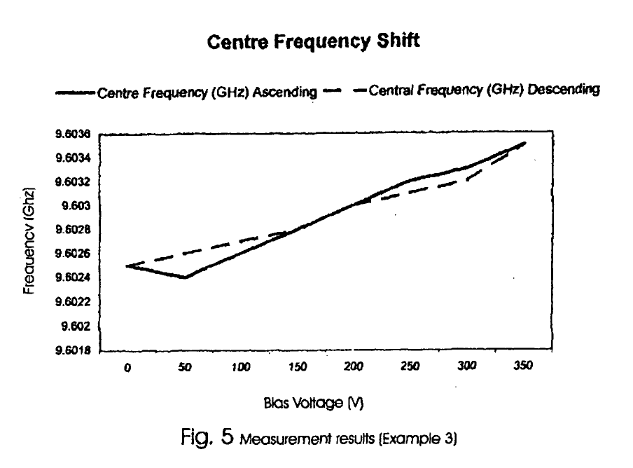

Graphs showing the results are shown in FIG. 5

### EXAMPLE 4

The procedure in example 3 was repeated except that the ferroelectric film was grown on the bottom cavity plate which resulted in shifting of the TE₀₁₁ mode by 2.1 MHz.

The results are shown in Table 4.

TABLE 4

| | Centre Frequency | Centre Frequency | |
|---|---|---|---|
| | (GHz) | (GHz) | Quality Factor |
| Bias Voltage (V) | (Ascending) | (Descending) | (Q) |
| 0 | 9.3958 | 9.3962 | 563 |
| 50 | 9.3954 | 9.3960 | 548 |
| 100 | 9.3960 | 9.3963 | 565 |
| 150 | 9.3969 | 9.3989 | 552 |
| 200 | 9.3978 | 9.3977 | 504 |
| 250 | 9.3979 | 9.3979 | 470 |

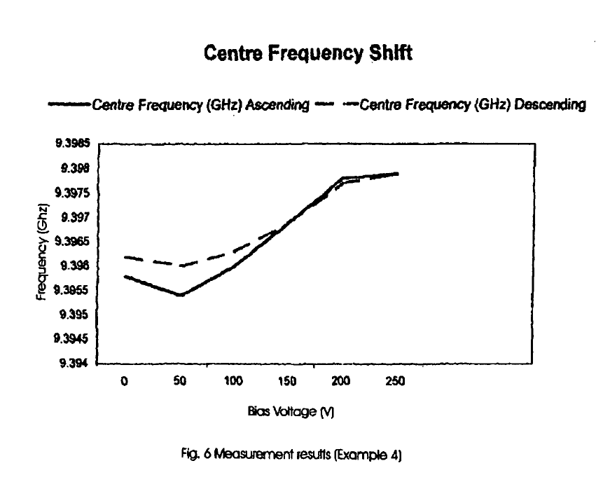

Graphs showing the results are shown in FIG. 6

1. A method of tuning a dielectric resonator which method comprises changing the frequency of the resonator by a frequency changing means which is operated using a ferroelectric element.

2. A method as claimed in claim 1 in which a dc bias is applied across the ferroelectric element to decrease the relative permittivity of the ferroelectric element which affects the dielectric resonator electric field and changes the resonance frequency of the resonator.

3. A method as claimed in claims 1 and 2 in which the dielectric resonator is mounted on a low loss low dielectric constant spacer.

4. A method as claimed in any one of claims 1 to 3 in which the ferroelectric element is ferroelectric film grown on a conductive substrate.

5. A method as claimed in any one of claims 1 to 3 in which the ferroelectric element is ferroelectric film grown on the resonator cavity bottom, the resonator upper plate, or on one or more of the resonator surrounding cavity walls.

6. A tuneable dielectric resonator which comprises a cavity within which is mounted a dielectric and a frequency changing means and in which the frequency changing means is operated using a ferroelectric element.

7. A tuneable dielectric resonator as claimed in claim 6 in which the ferroelectric element is mounted a low loss low dielectric constant spacer

8. A tuneable dielectric resonator as claimed in claim 6 or 7 in which the ferroelectric element is mounted on the resonator cavity bottom or resonator upper plate, or surrounding resonator cavity walls.

9. A tuneable dielectric resonator as claimed in any one of claims 6 to 8 in which the frequency changing means comprises a ferroelectric element on which is mounted a dielectric resonator and there are means to apply a dc bias to the ferroelectric element so as to decrease the relative permittivity of the ferroelectric element and affect the dielectric resonator electric field and so change the resonance frequency.

10. A tuneable dielectric resonator as claimed in any one of claims 6 to 9 in which the frequency changing means comprises a ferroelectric element surrounding a dielectric resonator and there are means to apply a dc bias to the ferroelectric element so as to decrease the relative permittivity of the ferroelectric element and affect the dielectric resonator electric field and so change the resonance frequency.

11. A tuneable dielectric resonator as claimed in any one of claims 6 to 10 in which the ferroelectric element is a ferroelectric film.

12. A tuneable dielectric resonator as claimed in claim 11 in which the ferroelectric film is mounted on a conductive base on which is positioned a spacer and the dielectric is mounted on the spacer.

13. A tuneable dielectric resonator as claimed in claim 12 in which the conductive base, on which there is formed the ferroelectric element, is supported on the floor of the resonator, the dielectric element and spacer are ring shaped, the spacer is positioned on the ferroelectric element and the dielectric element is placed on the spacer, and in which there is a wire electrode which passes through the spacer and the dielectric element and is connected to the ferroelectric element, there being a means to apply a dc bias to the ferroelectric element through the conductive base and the wire.

14. A tuneable dielectric resonator as claimed in any one of claims 6 to 13 in which the ferroelectric material is BaₓSr₁₋ₓTiO₃.

15. A tuneable dielectric resonator as claimed in any one of claims 6 to 14 which is capable of tuning up to 5% of the centre frequency.
